(19) United States
(12) Patent Application Publication
(10) Pub. No.: US 2020/0133653 A1
(43) Pub. Date: Apr. 30, 2020

(54) GENERATION OF RECOMMENDED MULTIFUNCTION PERIPHERAL FIRMWARE AND APPLICATIONS BASED ON GROUP MACHINE LEARNING

(71) Applicant: Toshiba TEC Kabushiki Kaisha, Shinagawa-ku (JP)

(72) Inventors: Ryan S. JOHNSON, Buena Park, CA (US); Louis ORMOND, Irvine, CA (US)

(21) Appl. No.: 16/172,316

(22) Filed: Oct. 26, 2018

(51) Int. Cl. G06F 8/65; G06F 8/61; G06F 17/30; G06F 8/77

(52) U.S. Cl. CPC G06F 8/65; G06F 8/77; G06F 17/30979; G06F 8/62

(57) ABSTRACT

A system and method for a system for machine learning generation of a customized and optimized list of candidate software for use on devices such as MFPs includes a processor and associated memory. A network interface communicates data with a plurality of multifunction peripherals. Inventory data corresponding to an inventory of software associated with each of a plurality of multifunction peripherals is received, along with software installation data corresponding to software installed each device. Device operation data corresponding to document processing operations completed on each multifunction peripheral is also received. The processor generates software installation recommendations specific to each multifunction peripheral in accordance with inventory data, software installation data and device operation data received from each of the plurality of multifunction peripherals.

### TECHNICAL FIELD

This application relates generally to generating an optimized listing of firmware or software options for multifunction peripherals. The application is more particularly directed to monitoring software installation histories, usage trends, user experiences and operational successes or failures to generate selectable list of software options most likely desired and most likely to function well.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Given the expense in obtaining and maintain MFPs, devices are frequently shared or monitored by users or technicians via a data network.

### BRIEF DESCRIPTION OF THE DRAWINGS

Various embodiments will become better understood with regard to the following description, appended claims and accompanying drawings wherein:

FIG. 1 is an example embodiment of a system machine learning generation of a customized and optimized list of candidate device software;

FIG. 2 is an example embodiment of a networked digital device;

FIG. 3 is an example embodiment of a digital data processing device;

FIG. 4 is an example embodiment of a platform for machine learning generation of a customized and optimized list of candidate software for use on a device; and

FIG. 5 is a flowchart of an example embodiment of machine learning generation of a customized and optimized list of candidate software for use on a device.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

In accordance with an example embodiment, a system for machine learning generation of a customized and optimized list of candidate software for use on devices such as MFPs includes a processor and associated memory. A network interface communicates data with a plurality of multifunction peripherals. Inventory data corresponding to an inventory of software associated with each of a plurality of multifunction peripherals is received, along with software installation data corresponding to software installed each device. Device operation data corresponding to document processing operations completed on each multifunction peripheral is also received. The processor generates software installation recommendations specific to each multifunction peripheral in accordance with inventory data, software installation data and device operation data received from each of the plurality of multifunction peripherals.

It is advantageous to monitor groups of devices, such as MFPs, in one device. One example of a management system is device management via a cloud portal. Devices connect to and report information to the cloud portal. An example of this is Toshiba's E-Bridge Cloud Connect. In addition to device monitoring, a cloud portal can oversee installation of device software, such application programs (apps) and firmware. A cloud portal is suitably provided with a software repository where software modules, such as firmware or applications, can be uploaded for use later by devices installations. In the case of firmware, this is suitably done by an administrator who uploads firmware and applications and publishes them for use by users.

There can be quite a few options and versions for software. A cloud portal could have hundreds of selections for available firmware or applications. This can be daunting, particularly when presented to someone who is less tech savvy.

As detailed in the example embodiments herein, a system is disclosed that can dynamically recommend a published app, firmware or firmware policy depending on the device and how the device is frequently used. Such recommendation is made in accordance with usage data, meter data from the device, and software installation data, including when software installed. Recommendations may also take into account how the device is being used, and how the device functions while running under identified software. Information gleaned from multiple MFPs can be used to augment successful suggestion of software that is best suited for a particular device's usage, which has features trending from other device usage, or which has demonstrate frequent use or fewer problems among the devices.

Example embodiments disclosed herein make use of device metrics, firmware and application information, and user usage through machine learning in order to recommend a firmware or application policy. Machine learning can determine optimal firmware or applications for a given device by looking up information for the firmware or application and checking trending device data. The most desirable items are suitably recommended to a user.

When the user selects a device in order to install firmware or an application, the system suitably looks up all installable applications and firmware to the selected device in order to narrow down candidates. Look up is also suitably made to determine what was previously recommended for the device or for similar devices, which may need to be done alone if there is no information for a particular device. Previously recommended firmware or applications are suitably weighted for increased desirability. However, if that firmware or application has since been removed, or if the device trending metrics reveal more print errors and failures, then weighting is suitably made for decrease desirability.

The system suitably looks up device metric trends for all other devices that have a given firmware or application installed. The more successful print jobs they have, the more desirable the firmware. If there were printing errors, then make the firmware less desirable.

For applications, or for firmware with unique features, the system suitably checks how often a feature may be used. If it is used often and has few errors, then the system suitably increases the desirability weighting. If there are several errors in its usage, then the system suitably decreases the desirability weighting. A look up of device metric trends for a selected device is suitably made, and a check is made whether the description within the firmware or application contains any matches for frequent operations. Examples include color printing, copying, black-and-white printing, stapling or hole punching. If so, then weighting can be adjusted toward an increased desirability.

Stability of all previous devices that has a given firmware or application installed is suitably checked. If a device has been less stable since installation, then a weighting can be adjusted toward a decreased desirability.

These operations provide for an evaluation of an overall desirability of each firmware or application and show the user the firmware or applications which may be most desirable. Recommendations can further be based on software popularity, such as may be indicated by an associated number of downloads.

Device trending metrics and usage data facilitates dynamic recommendations of new firmware or applications that are most suitable for the device and avoids downtime that may result with researching the new firmware or applications and their suitability for the device. This can further ensure that the firmware or applications selected will not impair device functionality.

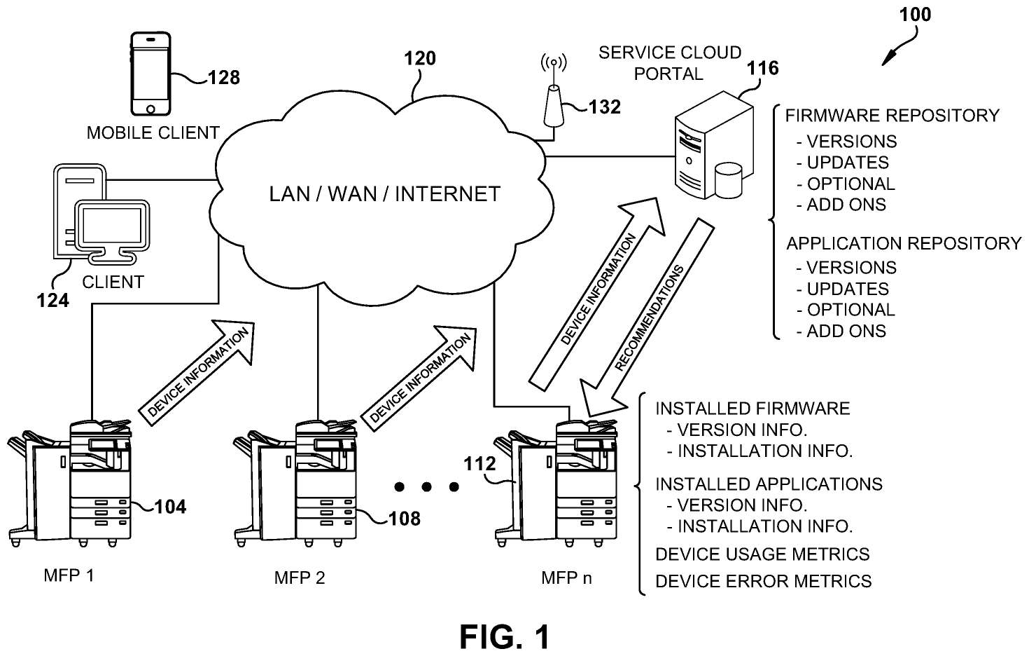

FIG. 1 illustrates an example embodiment of a system 100 for machine learning generation of a customized and optimized list of candidate software for use on an MFP. A plurality of MFPs, illustrated as MFPs 104, 108 and 112, are in data communication with service cloud portal server 116 via network cloud 120. Network cloud 120 is suitably comprised of a local area network (LAN), a wide area network (WAN) which may comprise the Internet, or any suitable combination thereof. A network administrator suitably accesses cloud server 116 or MFPs 104, 108 and 112 via a client computing device 124 suitably connected to the network cloud 120. An administrator may also access the device via a wireless data device, such as smartphone 128, suitably in wireless contact via a cellular, Wi-Fi or any suitable wireless connection via an access point 132.

Cloud server 116 stores software modules that are usable by MFPs, including MFP firmware, operating systems, middleware, policies and applications. MFPs are highly configurable devices and can include optional or alternative hardware or software. Examples of hardware options may include integrated hole punchers or staplers. Examples of software options include Toshiba Tec's OCR app which allows a scanned document to be edited, increasing post-scan utility. There may also be a relationship with hardware, firmware and applications, such as addition of a stapler device may require different firmware or an application to support its functionality.

When an administrator wishes to customize or configure an MFP, they can be faced with a daunting array of choices. They may be unaware of which choices are available for a particular MFP, unaware of potential problems associated with available selections, unaware as to which selections may be of greatest utility for the way their device is being used, or unaware of what is trending with other users which may be of added benefit for their device. This leads to less efficient device usage, wasted user time, and failure to implement valuable or desirable device features. In example embodiments disclosed herein, machine learning is applied to an array of inputs to determine, for each particular MFP, what software is available for it. Available software is suggested for use based on factors including the setup and usage of the particular MFP, as well as setups, usage, usage trends and monitored statuses of other networked MFPs.

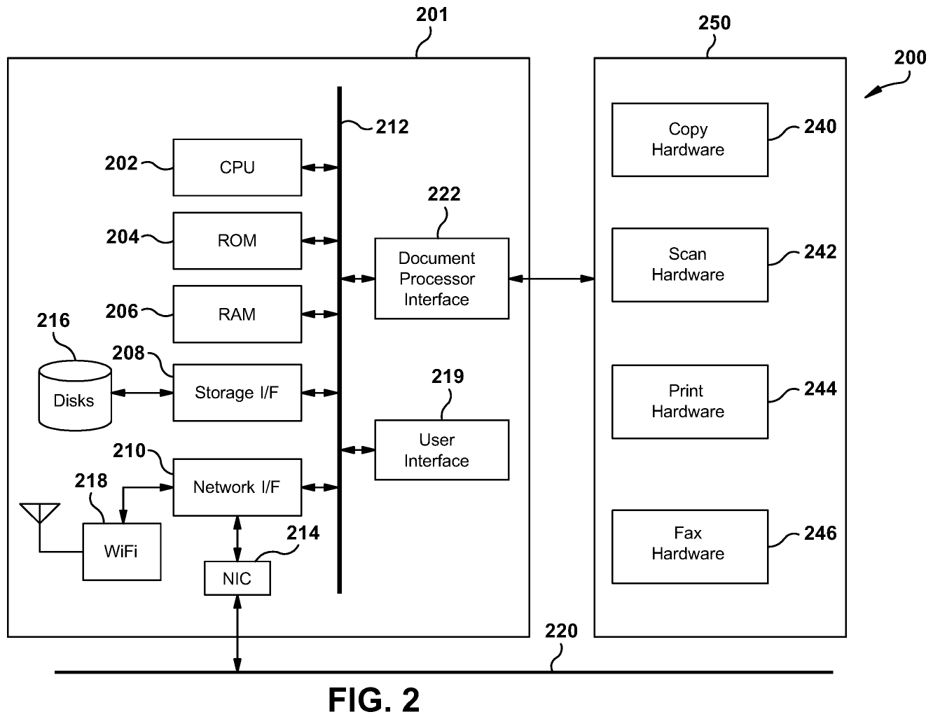

Turning now to FIG. 2 illustrated is an example embodiment of a networked digital device comprised of document rendering system 200 suitably comprised within an MFP, such as with MFPs 104, 108 and 112 of FIG. 1. It will be appreciated that an MFP includes an intelligent controller 201 which is itself a computer system. Thus, an MFP can itself function as a cloud server with the capabilities described herein. Included in controller 201 are one or more processors, such as that illustrated by processor 202. Each processor is suitably associated with non-volatile memory, such as ROM 204, and random access memory (RAM) 206, via a data bus 212.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via wireless network interface 218. Example wireless connections include cellular, Wi-Fi, Bluetooth, NFC, wireless universal serial bus (wireless USB), satellite, and the like. Example wired interfaces include Ethernet, USB, IEEE 1394 (FireWire), Apple Lightning, telephone line, or the like. Processor 202 is also in data communication with user interface 219 for interfacing with displays, keyboards, touchscreens, mice, trackballs and the like.

Also in data communication with data bus 212 is a document processor interface 222 suitable for data communication with MFP functional units. In the illustrated example, these units include copy hardware 240, scan hardware 242, print hardware 244 and fax hardware 246 which together comprise MFP functional hardware 250. It will be understood that functional units are suitably comprised of intelligent units, including any suitable hardware or software platform.

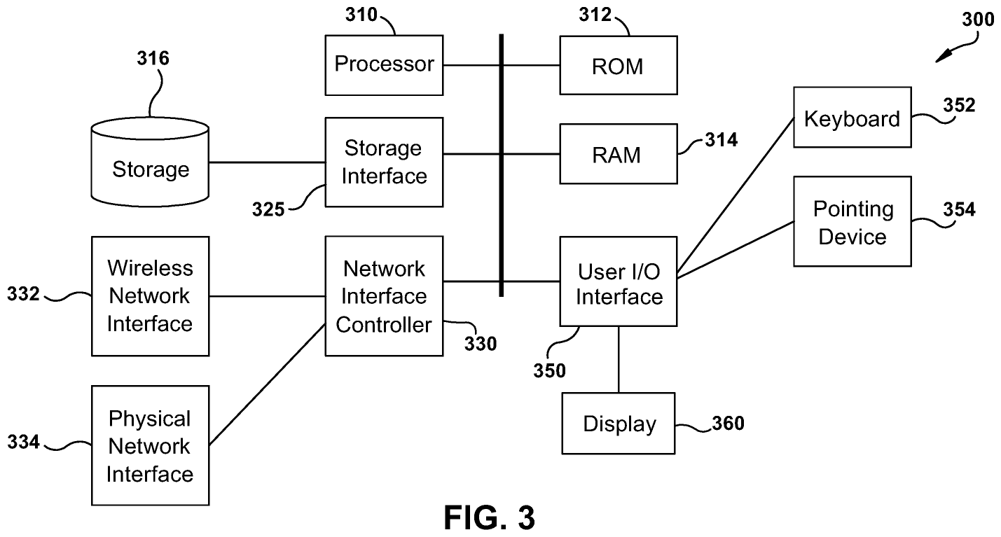

Turning now to FIG. 3, illustrated is an example embodiment of a digital data processing device 300 such as cloud server 116 of FIG. 1. Components of the data processing device 300 suitably include one or more processors, illustrated by processor 310, memory, suitably comprised of read-only memory 312 and random access memory 314, and bulk or other non-volatile storage 316, suitable connected via a storage interface 325. A network interface controller 330 suitably provides a gateway for data communication with other devices via wireless network interface 332 and physical network interface 334.

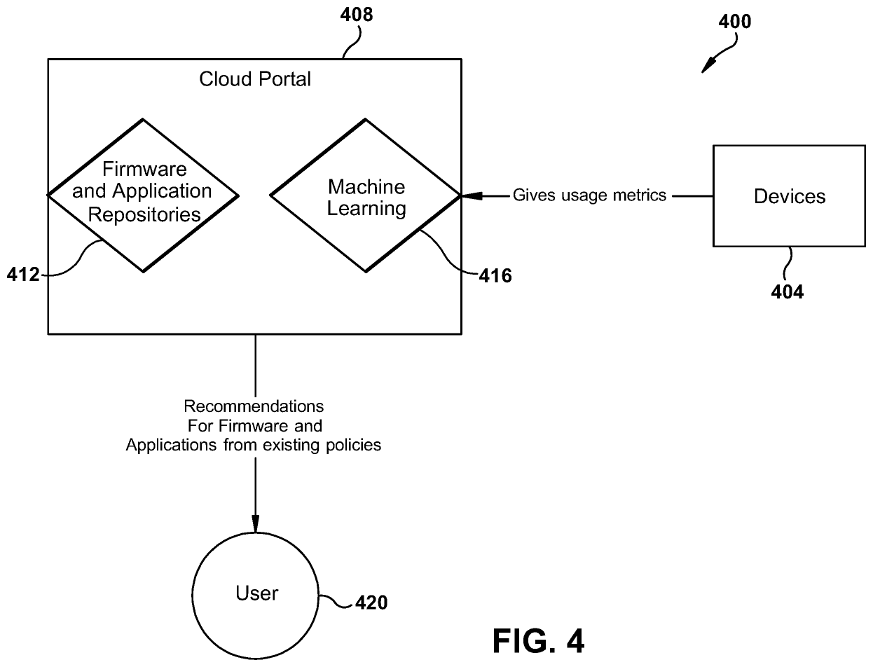

FIG. 4 is a block diagram of an example embodiment of a platform 400 for machine learning generation of a customized and optimized list of candidate software for use on an MFP. A group of devices 404, such as MFPs, provides information such as machine state, usage metrics, error codes, reboot data, device policies, software installation data, software usage data and the like to cloud portal 408. Cloud portal 408 includes a software repository 412, suitable comprising firmware, applications, operating systems, middleware or other device operation software usable by one or more MFPs to which it is connected. Cloud portal 408 also includes a machine learning module 416 operable for supervised or unsupervised machine learning, such as that described above. Cloud portal 408 engages machine learning on data received from devices 404 to provide software recommendations to one or more users associated with one or more MFPs, as illustrated by user 420.

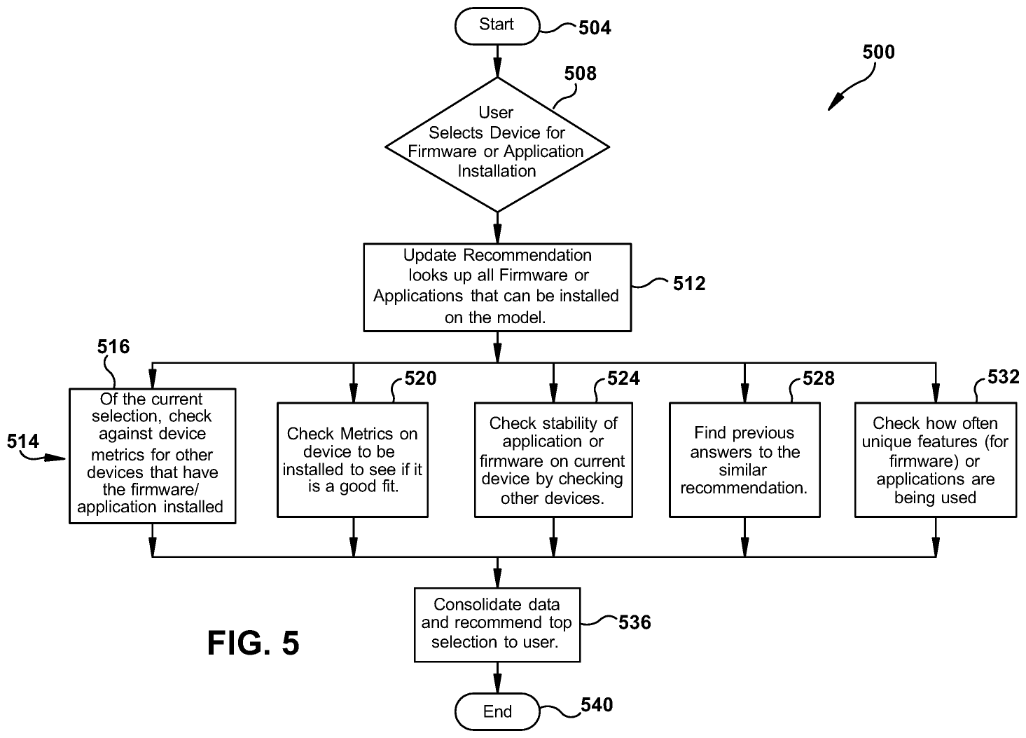

FIG. 5 is a flowchart 500 of an example embodiment of machine learning generation of a customized and optimized list of candidate software for use on an MFP. The process commences at block 504 and proceeds to block 508 where a user selects a device for software installation, such as an installation of applications or firmware. Next, an update to determine which software is available for the user's device is made at block 512. Next, a machine learning stage 514 includes multiple aspects for processing in no particular order. Block 516 checks device metrics of the selected device against other devices that have a similar software installation, such as firmware or applications. Block 520 checks metrics on the selected device to see what software may a good fit. Stability of software is checked relative to stability history on other devices a block 524. Previous answers relative to similar recommendations is made at block 528, and a check as to how often software, or software features, is being used is checked at block 532. Results from machine learning stage 514 are consolidated at block 536 and generate a list of top recommendations to the user at block 536. The process suitably terminates at block 540 until such time as another inquiry is received.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A system comprising:
a network interface configured for data communication with a plurality of multifunction peripherals; and
a processor and associated memory,
the processor configured to receive, from each multifunction peripheral, inventory data corresponding to an inventory of software associated therewith,
the processor further configured to receive, from each multifunction peripheral, software installation data corresponding to software installed thereon,
the processor further configured to receive, from each multifunction peripheral, device operation data corresponding to document processing operations completed thereon,
the processor further configured to determine, from device operation data, device metrics associated with device operation data for multifunction peripherals having commonly installed software as indicated by the software installation data,
the processor further configured to determine, from device operation data, device metrics associated with device operation data for multifunction peripherals that do not have the commonly installed software as indicated by the software installation data,
the processor further configured to determine acceptability of the commonly installed software on the one or more multifunction peripherals that do not have the commonly installed software in accordance with determined device metrics, and
the processor further configured to generate software installation recommendations relative to the commonly installed software specific to each multifunction peripheral that does not have the commonly installed software in accordance with determined acceptability.

2. The system of claim 1 further comprising:
a plurality of software modules associated with multifunction peripheral operation stored in the memory, and
wherein the processor is further configured to receive selection data corresponding to at least one software selection responsive to the software installation recommendations, and
wherein the processor is further configured to send a software module from the memory to a multifunction peripheral associated with a software selection.

3. The system of claim 2 wherein the software modules include multifunction peripheral firmware and multifunctional peripheral operation software.

4. The system of claim 3 wherein the inventory data includes data identifying currently installed software or firmware.

5. The system of claim 4 wherein software installation data includes temporal data relative to installed software.

6. The system of claim 5 wherein device operation data includes data relative to device status associated with running inventoried software.

7. The system of claim 6 wherein the processor is further configured to generate the software installation recommendations in accordance with device operation data acquired over a duration determined from the temporal data.

8. The system of claim 7 wherein the device operation data includes data associated with frequency of software use and success of software operation.

9. A method comprising:
receiving data from a plurality of multifunction peripherals via a network interface;
receiving, from each multifunction peripheral, inventory data corresponding to an inventory of software associated therewith;
receiving, from each multifunction peripheral, software installation data corresponding to software installed thereon;
receiving, from each multifunction peripheral, device operation data corresponding to document processing operations completed thereon;
determining, from device operation data, device metrics associated with device operation data for multifunction peripherals having commonly installed software as indicated by the software installation data,
determining, from device operation data, device metrics associated with device operation data for multifunction peripherals that do not have the commonly installed software as indicated by the software installation data,
determining acceptability of the commonly installed software on the one or more multifunction peripherals that do not have the commonly installed software in accordance with determined device metrics, and
generating, via a processor and associated memory, software installation recommendations relative to the commonly installed software specific to each multifunction peripheral that does not have the commonly installed software in accordance with determined acceptability.

10. The method of claim 9 further comprising:
storing a plurality of software modules associated with multifunction peripheral operation in the memory;
receiving selection data corresponding to at least one software selection responsive to the software installation recommendations; and
sending a software module from the memory to a multifunction peripheral associated with a software selection.

11. The method of claim 10 wherein the software modules include multifunction peripheral firmware and multifunctional peripheral operation software.

12. The method of claim 11 wherein the inventory data includes data identifying currently installed software or firmware.

13. The method of claim 12 wherein software installation data includes temporal data relative to installed software.

14. The method of claim 13 wherein device operation data includes data relative to device status associated with running inventoried software.

15. The method of claim 14 further comprising generating the software installation recommendations in accordance with device operation data acquired over a duration determined from the temporal data.

16. The method of claim 15 wherein the device operation data includes data associated with frequency of software use and success of software operation.

17. A system comprising:
a network interface configured for data communication with a plurality of multifunction peripherals; and
a processor and associated memory,
the processor configured to receive, from each multifunction peripheral, inventory data corresponding to an inventory of software associated therewith wherein the inventory data includes data identifying currently installed software or firmware,
the processor further configured to receive, from each multifunction peripheral, software installation data corresponding timing of software installations thereon,
the processor further configured to receive, from each multifunction peripheral, device operation data corresponding to document processing operations completed thereon wherein the device operation data includes data associated with frequency of software use and success of software operation relative to the timing,
the processor further configured to determine, from device operation data, device metrics associated with device operation data for multifunction peripherals having commonly installed software as indicated by the software installation data,
the processor further configured to determine, from device operation data, device metrics associated with device operation data for multifunction peripherals that do not have the commonly installed software as indicated by the software installation data,
the processor further configured to determine acceptability of the commonly installed software on the one or more multifunction peripherals that do not have the commonly installed software in accordance with determined device metrics,
the processor further configured to generate software installation recommendations relative to the commonly installed software specific to each multifunction peripheral that does not have the commonly installed software in accordance with determined acceptability,
a plurality of software modules associated with multifunction peripheral operation stored in the memory wherein the software modules include multifunction peripheral firmware or multifunctional peripheral operation software,
the processor further configured to receive selection data corresponding to at least one software selection responsive to the software installation recommendations, and
the processor further configured to send a software module from the memory to a multifunction peripheral associated with a software selection.

18. The system of claim 17 wherein the software installation data includes data associated with software removal.

19. The system of claim 17 wherein the device operation data includes data representative of document processing errors.

20. The system of claim 17 wherein the device operation data includes data relative to a use level of one or more multifunction peripheral operational features.
